(19) United States
(12) Patent Application Publication
(10) Pub. No.: US 2003/0221708 A1
(43) Pub. Date: Dec. 4, 2003

(54) Method of cleaning a semiconductor process chamber

(76) Inventors: Chun-Hao Ly, Versailles (FR); Yves Campidelli, Grenoble (FR)

Correspondence Address: E. Joseph Gess, BURNS, DOANE,, SWECKER & MATHIS, L.L.P., P.O. Box 1404, Alexandria, VA, 22313-1404, US

(21) Appl. No.: 10/160,240

(22) Filed: Jun. 4, 2002

(51) Int. Cl. B08B 9/46

(52) U.S. Cl. 134/18; 134/21

(57) ABSTRACT

Provided is a novel method of cleaning a semiconductor process chamber having deposits on an inner surface thereof. The method involves: (a) introducing a cleaning gas comprising hydrogen chloride into the process chamber, wherein the cleaning gas is effective to react with and remove the deposits from the inner surface of the process chamber; (b) removing gas from the process chamber; and (c) monitoring at least a portion of the removed gas for a species indicative of an endpoint of the chamber cleaning. The invention allows for the cleaning of semiconductor process chambers in an efficient manner so as to reduce process down time and improve process throughput. The method can be applied to in-line analysis.

### BACKGROUND OF THE INVENTION

1. Field of the Invention

The present invention relates to novel methods of cleaning a semiconductor process chamber having deposits on an inner surface thereof. The invention has particular applicability to the cleaning of chemical vapor deposition (CVD) and epitaxial growth reactors used for the deposition of silicon and germanium, as well as silicon-containing and germanium-containing films, on the surface of a semiconductor wafer.

2. Description of the Related Art

In the semiconductor manufacturing industry, deposition processes such as chemical vapor deposition (CVD) and epitaxial growth are employed to deposit silicon (Si) and germanium (Ge) films, as well as other silicon- and germanium-containing films on a wafer surface. For example, doped and undoped polycrystalline-silicon (polySi), -germanium (polyGe), and -silicon-germanium (polySiGe) films are typically deposited by low pressure chemical vapor deposition (LPCVD). Epitaxial growth is used to form single crystalline films, for example, single crystalline silicon (Si), germanium (Ge), silicon-germanium (SiGe) and silicon-germanium-carbon (SiGeC). These films are often doped, for example, with arsenic (As), boron (B) or phosphorus (P).

During the deposition process, the material being formed on the wafer surface is also undesirably deposited on other interior surfaces of the process chamber. With each process run, the deposits inside the chamber build up to a point at which the process is detrimentally affected. For example, the deposits may peel off from the chamber walls and land on the wafer surface forming particulate contamination, resulting in defects in the final product devices. In addition, film quality and thickness uniformity as well as process reproducibility can be adversely affected by the deposits.

To avoid such problems associated with the buildup of deposits inside the process chamber, it is known to periodically clean the process chamber interior. Such cleaning is conducted between product runs after removal from the process chamber of the wafer(s) being treated. The use of hydrogen chloride (HCl) as a chamber cleaning gas for silicon-containing and germanium-containing deposits is also known. The HCl reacts with and volatilizes the deposits on the chamber surfaces. The reaction products are continuously removed from the process chamber through the chamber exhaust.

The cleaning method is typically conducted at atmospheric or sub-atmospheric pressure, and at temperatures in excess of 1000° C. The chamber is typically cleaned between each process run with a cleaning time on the order of six to ten minutes. Alternatively, chamber cleaning may be performed following a predetermined number of product runs and/or after a predetermined total thickness of film has been deposited. The cleaning time is typically specified by the process tool manufacturer, with a large excess of time being employed to ensure complete removal of the deposits.

The conventional HCl cleaning process can be very time intensive, particulary in the case of lower temperature cleaning and single-wafer process tools. During chamber cleaning, product wafer processing in the chamber cannot take place. Process tool down time in a semiconductor manufacturing plant is, however, extremely costly in terms of lost product. This problem is aggravated as a result of the large excess of process time used in the conventional cleaning process to ensure complete removal of the deposits from the process chamber interior.

### SUMMARY OF THE INVENTION

To overcome or conspicuously ameliorate the problems associated with conventional methods of semiconductor process chamber cleaning, it is an object of the invention to provide a novel method of cleaning a semiconductor process chamber having deposits on an inner surface thereof. In accordance with a first aspect of the invention, the method comprises: (a) introducing a cleaning gas comprising hydrogen chloride into the process chamber, wherein the cleaning gas is effective to react with and remove the deposits from the inner surface of the process chamber; (b) removing gas from the process chamber; and (c) monitoring at least a portion of the removed gas for a species indicative of an endpoint of the chamber cleaning.

The invention allows for the cleaning of a semiconductor process chamber in an expeditious manner so as to reduce process down time and thereby improve throughput. In particular, progress of the chamber cleaning can be followed in real time by monitoring the effluent from the process chamber for a species which is indicative of an endpoint of the chamber cleaning. In this way, the process can be terminated as soon as the deposits are completely removed from the chamber walls, thus eliminating the use of an excess amount of time as a margin of safety as used in conventional cleaning processes.

The cleaning method in accordance with the invention is particularly useful in process development for establishing a suitable chamber cleaning recipe as well as for on-line control in manufacturing. Both the effectiveness and efficiency of the chamber cleaning can effectively be assessed.

According to a second aspect of the invention, provided is a method of cleaning a semiconductor process chamber having silicon-containing deposits on an inner surface thereof. The method comprises (a) introducing a cleaning gas comprising hydrogen chloride into the process chamber; and (b) continuously monitoring a reactant or a product of the reaction between the hydrogen chloride and the silicon- or germanium-containing deposits with a mass spectrometer.

Other objects and aspects of the present invention will become apparent to one of ordinary skill in the art on a review of the specification, drawings and claims appended hereto.

### BRIEF DESCRIPTION OF THE DRAWINGS

The objects and advantages of the invention will become apparent from the following detailed description of the preferred embodiments thereof in connection with the accompanying drawings, in which:

FIG. 1 illustrates a system used for cleaning a chamber in accordance with an exemplary aspect of the invention; and

FIG. 2 is a graph generated by a mass spectrometer of intensity versus cleaning time for HCl and SiCl₄ during a conventional chamber cleaning process.

### DETAILED DESCRIPTION OF PREFERRED EMBODIMENTS OF THE INVENTION

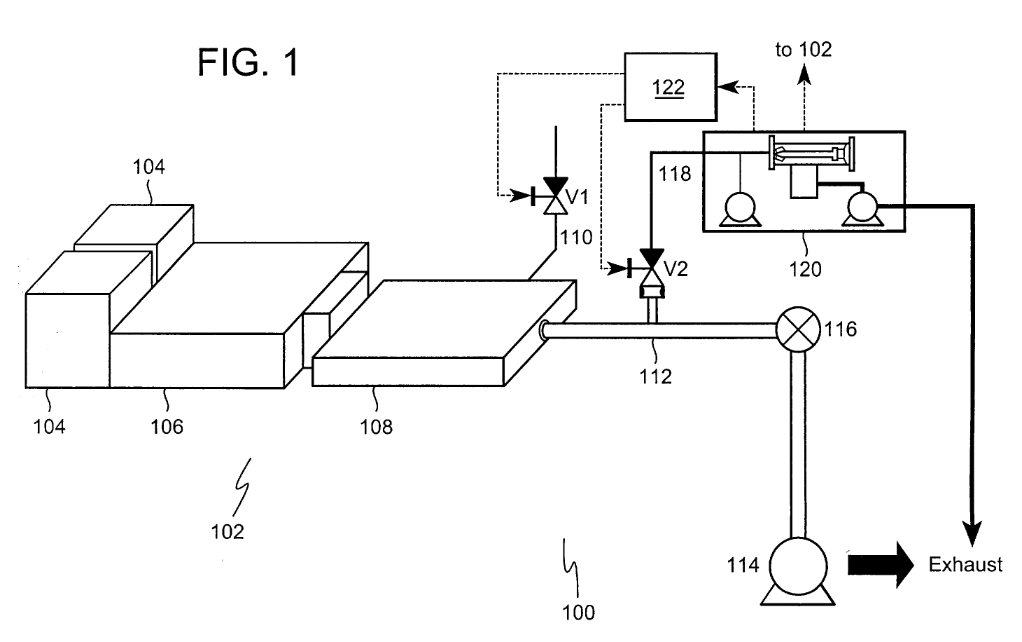

The invention will now be described with reference to FIG. 1, which illustrates a system 100 which can be used for cleaning a process chamber in accordance with one aspect of the invention. The system shown in FIG. 1 is merely exemplary and other configurations can be employed.

The cleaning system 100 includes a semiconductor processing tool 102 which is used for deposition or growth of a film on a wafer surface. The terms “deposition” and “growth” in these and in their other forms are used interchangeably. The processing tool 102 can be, for example, a CVD or epitaxial growth reactor used to deposit silicon-containing and/or germanium-containing films on a wafer surface such as single-crystalline or polycrystalline silicon and germanium, as well as other silicon- and germanium-containing films such as silicon-germanium and silicon-germanium carbon. These films can be doped with one or more dopant impurities, for example, with arsenic, boron or phosphorus.

The exemplary process tool 102 includes load-lock chambers 104, a wafer transfer chamber 106 and a process chamber 108. The process chamber is typically formed of quartz or silicon carbide (SiC). Heaters are provided for heating the interior of the process chamber for carrying out the CVD or epitaxial growth process, as well as the chamber cleaning process. In the case of a quartz process chamber, lamp heaters above and below the chamber (see arrows) are preferred. While cleaning temperature will depend on various factors such as the particular apparatus, chamber configuration and deposited material, typical temperature for the chamber cleaning method is from about 900 to 1300° C., preferably from about 1050 to 1200° C., more preferably about 1190° C. The temperature can be constant during the cleaning process or, alternatively, can be varied as the cleaning process progresses.

A cleaning gas line 110 is provided for introducing a cleaning gas comprising hydrogen chloride into the process chamber. An automatic valve V1 and mass flow controller (not shown) are provided in line 110 for controlling the flow of the cleaning gas in the process chamber. Additional gas lines (not shown) are provided for introducing process gases to the process chamber for wafer treatment, and for introducing an inert purge gas into the load-lock, wafer transfer and process chambers.

The hydrogen chloride is preferably mixed with an additional gas such as hydrogen in a ratio, for example, of from about 15 to 85 vol %, preferably from about 20 to 60 vol %, hydrogen chloride to 85 to 15 vol %, preferably from about 80 to 40 vol %, hydrogen. The gases are typically premixed but can be separately introduced into the process chamber through separate gas lines. The hydrogen chloride is typically introduced into the process chamber at a flowrate of from about 10 to 30 slm. Depending on the process chamber configuration, it may be desirable to alter the total flow rate of the cleaning gas during the cleaning process to optimize cleaning performance. For example, it may be desirable to increase or decrease the flow rate to adequately clean different regions of the process chamber.

The cleaning process is typically performed at a temperature of from about 900 to 1300° C. Ideally, the temperature of the cleaning process is the same as or close to that used for the deposition process. In this way, time required for temperature ramp-up and ramp-down between the deposition process and chamber cleaning process can be minimized or eliminated.

An exhaust line 112 and vacuum pump 114 are provided for removing gas from the process chamber. The exhaust line also includes a throttle valve 116 to help maintain a constant pressure in the process chamber. The pump is typically connected to a scrubber or other waste gas treatment system. The pressure inside of the process chamber during chamber cleaning is typically from low pressure to about atmospheric pressure, for example, from about 600 to 760 Torr.

A sample line 118 is connected to the exhaust line 112 for continuously removing a sample of the exhaust gas therefrom. An automatic valve V2 in sample line 118 is provided for controlling the flow of gas therein. A monitoring system 120 is disposed in-line with the sample line for monitoring the gas passing through the sample line for a species indicative of an endpoint of the chamber cleaning. Alternative configurations can be used for the sample line and monitoring system. For example, the sample line can be connected directly to the process chamber or the monitoring system can be disposed in-line with the exhaust line 112 depending on the requirements, for example, flow and pressure requirements, of the monitoring system. For sub-atmospheric pressure processes, the sampling point for the monitoring system can alternatively be located downstream of the vacuum pump 114.

The monitoring system 120 is typically used only during the cleaning process. The species to be monitored will depend on the particular material deposited inside the process chamber and the product of reaction of that material with the HCl cleaning gas. For example, for silicon-containing films, for example, for doped or undoped polysilicon films or silicon epitaxial films, it is preferred to monitor SiCl₄ in the process chamber exhaust. SiCl₄ is a product of the reaction between the silicon-containing deposits and HCl cleaning gas. Once the deposits have been completely removed from the walls of the process chamber, the SiCl₄ is no longer detected in the exhaust gas or drops to a background level (due, for example, to etching of an SiC wafer susceptor), indicating the endpoint of the cleaning process. For doped or undoped germanium-containing films, the preferred species of interest would include GeCl₄. For doped or undoped silicon germanium (SiGe)films, the preferred species of interest would include SiCl₄ or GeCl₄. Instead of monitoring the reaction product, the level of the reactant HCl in the chamber effluent can be monitored. In such case, the HCl would initially be consumed by its reaction with the deposits and thus have a low presence in the exhaust gas. As the deposits are removed, the HCl content of the exhaust gas increases until reaching a substantially constant level.

The monitoring system is preferably a mass selective-type system, for example, a mass spectrometry system, preferably a quadrupole mass spectrometry (QMS) system. The species of interest, SiCl₄, GeCl₄ and HCl, can all be easily monitored by such techniques. The flowrate in the sample line for mass spectrometry is typically from about 150 to 250 sccm, preferably from about 190 to 210 sccm, more preferably about 200 sccm. Other types of measurement systems can alternatively be employed as long as they are capable of continuously monitoring the species indicative of an endpoint of the chamber cleaning. Absorption spectroscopy techniques, for example, may be used as long as they have sufficient sensitivity to a species indicative of an endpoint of the cleaning process. The sensors, whether based on mass spectrometry, absorption or some other technique can be species-dedicated sensors.

In the exemplary embodiment, the monitoring system 120 is a quadrupole mass spectrometer system. Suitable such systems are commercially available, for example, the Ultratrace Smart IQ+, from VG Gas, a division of Thermco Instrument Systems. For cleaning processes taking place at atmospheric pressure, a QMS with a closed ion source and a capillary used as the sampling line 118 is preferably employed. In such case, the capillary diameter and length are selected to introduce a pressure gradient suitable for normal operation of the QMS. Alternatively, the cleaning process can be conducted under vacuum, in which case a QMS with an open ion source is preferably used.

In accordance with a preferred aspect of the invention, a control signal from the monitoring system 120 can be sent to a controller 122. The controller 122 in turn sends control signals to different components in order to control various operations. The controller 120 can take various forms known to persons skilled in the art, but is preferably a programmable logic controller (PLC) or other type of logic controller. A feedback control loop technique can be implemented with the controller 122 and the valve/flow control system and other components and controllers of the semiconductor processing tool 102. In this way, the valves and other flow control devices can be automatically controlled based on the measurements of the monitoring system 120. For example, when the monitoring system 120 detects that the cleaning process is complete, a control signal can be sent by the controller 122 to valve V1 to shut off the supply of cleaning gas and to valve V2 to shut off gas flow to the monitoring system. The controller 122 can further control operation of the semiconductor processing tool 102 by instructing it to begin wafer processing through control of the tool's wafer transfer, vacuum and gas flow control systems.

The beneficial results that can be obtained through the present invention can be understood upon review of the following example.

### EXAMPLE 1

An ASM Epsilon One epitaxial growth reactor and a VG Gas Ultratrace Smart IQ+ quadrupole mass spectrometer were employed in the configuration illustrated in FIG. 1 to clean deposits from the interior of a process chamber using a standard cleaning process. Prior to the cleaning process, 3000 Å of SiGe were deposited on a wafer in the epitaxial growth reactor.

The process chamber 108 was evacuated and the temperature was raised to 1190° C. In a first step of the cleaning process, 50 vol % hydrogen chloride/hydrogen was introduced into the process chamber at a flowrate of 40 slm (20 slm HCl and 20 slm H₂) for a period of two minutes. A second cleaning step followed, in which the flowrate of the hydrogen was increased to 80 slm while keeping the HCl flow rate constant, resulting in a 20 vol % hydrogen chloride/hydrogen mixture, for a period of two minutes. During the cleaning process, HCl and SiCl₄ levels in the exhaust gas were continuously monitored with the mass spectrometer. The pressure in the measurement system analysis chamber was 2.1×10⁻⁶ torr, and that in the sample gas line upstream of the measurement system was 4 torr.

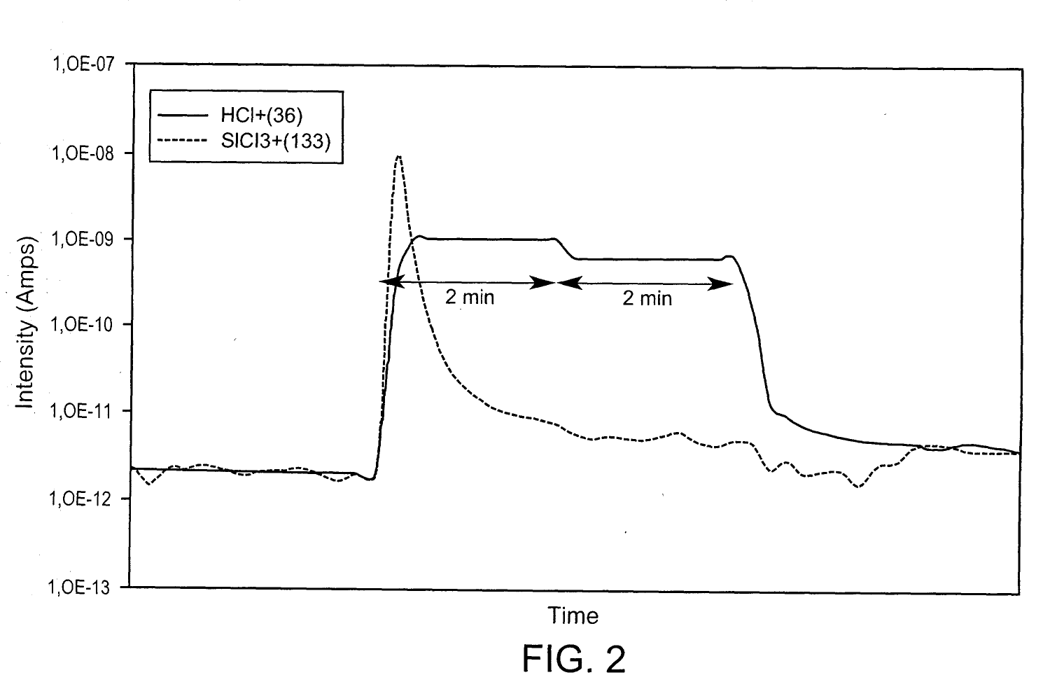

FIG. 2 is a graph of the measured intensity versus cleaning time for HCl+(36) and SiCl₃+(133), which are indicative of the level of unreacted HCl reactant and reaction product SiCl₄, respectively, in the process chamber during the chamber cleaning process. As can be seen, the SiCl₃+(133) intensity increased sharply to a peak just after onset of the cleaning process, followed by a fairly sharp decrease, indicating that the deposits were substantially removed from the chamber walls after about one minute of cleaning. A further gradual decrease in intensity due to etching of the wafer susceptor occurs after the deposits are removed from the chamber walls. The HCl+(36) intensity level reached a first plateau after less than one minute into the cleaning process, indicating no further consumption of the HCl (i.e., complete reaction with the deposits), and then a second plateau coinciding with the increased flow rate during the second phase of the cleaning process. The HCl intensity level dropoff after the second plateau coincided with the shutting off of the cleaning gases.

These results demonstrate that chamber cleaning is actually completed in a significantly shorter period of time than the actual cleaning time employed in standard cleaning recipes. The present cleaning method allows for progress of the chamber cleaning to be followed in real time, thereby minimizing the excessive time margin built into cleaning recipes, and increasing production throughput.

While the invention has been described in detail with reference to specific embodiments thereof, it will be apparent to one skilled in the art that various changes and modifications can be made, and equivalents employed, without departing from the scope of the appended claims.

What is claimed is:

1. A method of cleaning a semiconductor process chamber having deposits on an inner surface thereof, comprising:
(a) introducing a cleaning gas comprising hydrogen chloride into the process chamber, wherein the cleaning gas is effective to react with and remove the deposits from the inner surface of the process chamber;
(b) removing gas from the process chamber; and
(c) monitoring with a monitoring system at least a portion of the removed gas for a species indicative of an endpoint of the chamber cleaning.

2. The method according to claim 1, further comprising:
(d) automatically controlling one or more functions based on output from the monitoring system.

3. The method according to claim 2, wherein the one or more functions comprise flow of the cleaning gas into the process chamber.

4. The method according to claim 3, wherein the flow of the cleaning gas into the chamber is stopped when the species reaches a predetermined level.

5. The method according to claim 1, wherein the monitoring system is a mass spectrometer system.

6. The method according to claim 5, wherein the monitoring system is a quadrupole mass spectrometer.

7. The method according to claim 1, wherein the cleaning process is conducted at about atmospheric pressure.

8. The method according to claim 1, wherein the cleaning process is conducted under vacuum.

9. The method according to claim 1, wherein the semiconductor process chamber forms part of an epitaxial growth reactor or a chemical vapor deposition reactor for depositing a silicon- or germanium-containing film, the film being doped or undoped.

10. The method according to claim 1, wherein the species being monitored comprises chlorine.

11. The method according to claim 10, wherein the species being monitored is SiCl₄, GeCl₄ or HCl.

12. A method of cleaning a semiconductor process chamber having silicon- or germanium-containing deposits on an inner surface thereof, comprising:
(a) introducing a cleaning gas comprising hydrogen chloride into the process chamber; and
(b) continuously monitoring a reactant or a product of the reaction between the hydrogen chloride and the silicon- or germanium-containing deposits with a mass spectrometer.

13. The method according to claim 12, further comprising:
(c) automatically controlling one or more functions based on output from the mass spectrometer.

14. The method according to claim 13, wherein the one or more functions comprise flow of the cleaning gas into the process chamber.

15. The method according to claim 13, wherein the flow of the cleaning gas into the chamber is stopped when the monitored reactant or product reaches a predetermined level.

16. The method according to claim 12, wherein the monitoring system is a quadrupole mass spectrometer.

17. The method according to claim 12, wherein the semiconductor process chamber forms part of an epitaxial growth reactor for depositing single crystalline silicon or silicon-containing films or a chemical vapor deposition reactor for depositing polysilicon films, the films being doped or undoped.

18. The method according to claim 12, wherein the species being monitored is SiCl₄, GeCl₄ or HCl.

19. The method according to claim 18, wherein the species being monitored is SiCl₄ or HCl.

20. The method according to claim 18, wherein the species being monitored is GeCl₄.
